(19) United States
(12) Patent Application Publication
(10) Pub. No.: US 2010/0144370 A1
(43) Pub. Date: Jun. 10, 2010

(54) METHOD AND SYSTEM OF LOCATING MOBILE TERMINAL

(75) Inventor: Seok Min JANG, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/622,643

(22) Filed: Nov. 20, 2009

(30) Foreign Application Priority Data
Dec. 9, 2008 (KR) 10-2008-0124569

(51) Int. Cl. H04W 24/00

(52) U.S. Cl. 455/456.2

(57) ABSTRACT

A method and a system for locating a mobile terminal using an assisted global positioning system are disclosed. The base station promptly and precisely locates a mobile terminal so that emergency action may be taken immediately. In an exemplary embodiment, the base station transmits the determined location of the caller terminal to a Public Safety Answering Point (PSAP) of an enhanced 911 (E911) Location Information System.

### CLAIM OF PRIORITY

This application claims priority from an application entitled “METHOD AND SYSTEM OF LOCATING MOBILE TERMINAL” filed in the Korean Intellectual Property Office on Dec. 9, 2008 and assigned Serial No. 10-2008-0124569, the contents of which are incorporated herein by reference in its entirety.

### BACKGROUND OF THE INVENTION

1. Field of the Invention

The present invention relates generally to a method and a system of locating a mobile terminal. More particularly, the present invention relates to a method of locating a mobile terminal on the basis of an Assisted Global Positioning System (AGPS) and a system in particular in emergency situations.

2. Description of the Related Art

An emergency locating system refers to a system for quickly determining a location of an endangered person in case of emergency, for example, enhanced 911 (E911) Location Information System of North America. Since obtaining the location of the endangered person is very important for saving the life of the endangered person by the emergency locating system, the location of the endangered person must be determined rapidly and correctly to provide the required emergency assistance. The emergency may include those requiring assistance from acts of terrorism.

The emergency locating system generally determines the location of who is calling for help using the Assisted Global Positioning System (AGPS). In more detail, the endangered person is calling an emergency rescue party for help using his/her own mobile terminal. When the call signal is transmitted to a base station, the base station receives information (GPS signal information) for locating the mobile terminal from the mobile terminal and determines the position of the mobile terminal to transmit the approximate location of the endangered person to the emergency rescue party. Thus, the emergency rescue party may determine the current location of the endangered person when the endangered person calls the emergency rescue party.

In this case, performance of a GPS module provided in the mobile terminal belonging to the endangered person is deteriorated or inferior, for example, when the mobile terminal is located at a multipath region or a region where the mobile terminal is surrounded by numerous multistory buildings that cause difficulty in reception of GPS signals, an error becomes large, and response speed is slowed when attempting to locate the person calling for help. Thus, the emergency rescue party has difficulty in locating the person calling for help, such that it may be difficult or not possible for the emergency rescue party to rapidly rescue the endangered person. In the case of, for example, accidents or sudden illness, the time spent trying to locate the person requiring emergency assistance may well be the determine whether the person shall live or die. Therefore, a method of rapidly and correctly locating a mobile terminal is required in the emergency locating system.

### SUMMARY OF THE INVENTION

The present invention has been made to provide a method of rapidly and correctly locating a mobile terminal in an Assisted Global Positioning System-based location system.

The present invention also provides a location system using the above-mentioned method.

Both the method and system according to the present invention can result in enhanced emergency response due to the increased accuracy of the person in need of assistance with a mobile terminal than known heretofore.

In accordance with an exemplary embodiment of the present invention, there is provided an assisted global positioning system based locating system that functions by transmitting assistance data to a caller terminal transmitting a call signal and at least one other terminal when the caller terminal transmits the call signal; receiving GPS satellite signal information from the caller terminal and the at least one other terminal; determining a location of the caller terminal and a location of the at least one other terminal based on the assistance data and the GPS satellite signal information; and estimating a location range of the caller terminal by correcting the location range of the caller terminal using the location of the at least one other terminal and a location of a base station.

In determining the location of the caller terminal, an error between a real location of the base station and an estimated location of the base station (estimated from a GPS satellite signal) is applied to the location of the caller terminal and the location of the at least one other terminal to determine the locations of the caller terminal and the at least one another terminal.

In accordance with another exemplary embodiment of the present invention, there is provided an assisted global positioning system based locating system, including: a plurality of mobile terminals, each of which includes a GPS module; and a base station transmitting assistance data to the mobile terminals when a call signal is received from one of the mobile terminals, determining locations of the mobile terminals based on GPS satellite signal information and the assistance data when the GPS satellite signal information is received from the mobile terminals, and estimating a location range of the mobile terminal which transmitted the call signal using the locations of the mobile terminals excluding the mobile terminal which transmitted the call signal and a location of the base station.

According to an aspect of the present invention, the base station may rapidly and correctly locate a mobile terminal so that prompt countermeasures to the emergency circumstances may be facilitated.

### BRIEF DESCRIPTION OF THE DRAWINGS

The features and advantages of the present invention will become more apparent from the following detailed description in conjunction with the accompanying drawings, in which:

FIG. 1 is a schematic view illustrating an emergency location system according to an exemplary embodiment of the present invention;

FIG. 2 is a block diagram illustrating a mobile terminal employed in the location system according to the exemplary embodiment of the present invention;

FIG. 3 is a flowchart illustrating a method of locating a mobile terminal according to an exemplary embodiment of the present invention; and

FIG. 4 is a schematic view illustrating data transmission between a base station and mobile terminals according to an exemplary embodiment of the present invention.

### DETAILED DESCRIPTION

In the following detailed description, the term ‘assistance data’ refers to data received by a mobile terminal from a location server. The term ‘assistance data’ in an assisted global positioning system contains information on a satellite, particularly, correction parameters transmitted by satellites such as a PRN number of a visible satellite, Ephemeris data, clock error correction, and ionosphere correction, and Doppler and phase information of GPS satellite signals.

Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring appreciation of the subject matter of the present invention by a person of ordinary skill in the art.

Particular terms may be defined to describe the invention in the best mode. Accordingly, the meaning of specific terms or words used in the specification and the claims should not be limited to the literal or commonly employed sense, but should be construed in accordance with the spirit of the invention. The description of the various embodiments is to be construed as exemplary and provided only for illustrative purposes, and does not describe every possible instance of the invention. Therefore, a person of ordinary skill in the art understands and appreciates that various changes may be made and equivalents may be substituted for elements of the invention referred to in the detailed description and the appended claims.

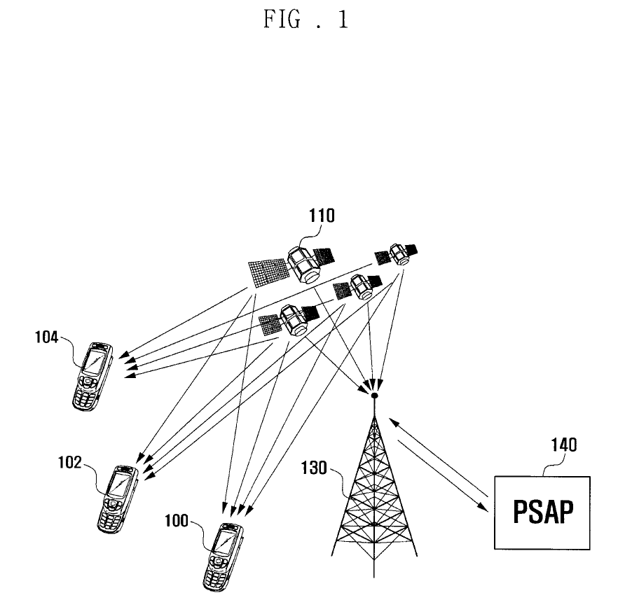

FIG. 1 is a schematic view illustrating an emergency location system according to an exemplary embodiment of the present invention.

The emergency locating system according to an exemplary embodiment of the present invention includes mobile terminals 100, 102, and 104, a plurality of GPS satellites 110, a base station 130, and a public safety answering point (PSAP) 140.

Each of the mobile terminals 100, 102, and 104 employed in this exemplary embodiment of the present invention includes a GPS module. The mobile terminal 100 is a mobile terminal to transmit an emergency call signal to the base station 130. When a user of the mobile terminal 100 inputs an emergency rescue telephone number, for example, ‘911’ to call for help, an emergency call signal is transmitted to the base station 130. The mobile terminals 102 and 104 transmit GPS satellite signal information to the base station 130 according to commands from the base station 130. The base station 130 estimates a location range of the mobile terminal 100 by adjusting the location of the mobile terminal 100 by using locations of the base station 130 and the mobile terminals 102 and 104. FIG. 1 shows only the mobile terminals 102 and 104 as mobile terminals to transmit the GPS satellite signal information to the base station 130 for location purposes of another mobile terminal, such as mobile terminal 100. However, the present invention is not limited to the above description as two or more mobile terminals may transmit the GPS satellite signal information.

Each of the plurality of GPS satellites 110 broadcast GPS satellite signals to the base station 130 and the mobile terminals 100, 102, and 104. Each of the plurality GPS satellites 110 is one of twenty-four satellites orbiting the earth on six orbital planes that broadcast the GPS satellite signals to the mobile terminals 100, 102, and 104. The GPS satellites 110 are placed preferably such that a user of a mobile terminal may receive signals from at least five GPS satellites and each of the GPS satellites transmits two GPS satellite signals at two L-band frequencies L1 and L2. A precise (P) code and coarse/acquisition (C/A) code are carried at the frequency L1 and the P code is carried at the frequency L2.

Still referring to FIG. 1, the base station 130 receives radio waves from the mobile terminals 100, 102, and 104 and switches of mobile communication networks and facilitates the mobile communications. The base station 130 employed in this exemplary embodiment of the present invention may include a location server (not shown) used in the AGPS.

When the location server receives assistance data from the GPS satellites 110 to provide the received assistance data to the mobile terminals 100, 102, and 104, preferably the mobile terminals 100, 102, and 104, which receive the assistance data, each receive the GPS satellite signals from the GPS satellites 110 using the assistance data. The location server may directly calculate the location of a mobile terminal using information on the GPS satellite signals received from the mobile terminal in addition to the transmission of the assistance data to the mobile terminal. The base station 130, in this exemplary embodiment of the present invention, transmits the assistance data to the mobile terminals, receives data for determining the locations of the mobile terminals (information on GPS satellite signals) from the mobile terminals 100, 102, and 104 that received the assistance data, and calculates the locations of the mobile terminals 100, 102, and 104.

The PSAP 140, which is referred to as a public safety answering point, and the 911 emergency rescue center of North America being one example thereof. A complicated computer telephone communication system, in which, when a phone call is routed to the nearest PSAP 140, the PSAP 140 points out the emergency situation correctly to ensure that a proper response team is sent, belong to the PSAP 140. The PSAP 140 recognizes the fact that reporting of an emergency event has occurred and the position of the reported emergency event when a phone call and the location information from the base station 130 are received, without the caller providing such information.

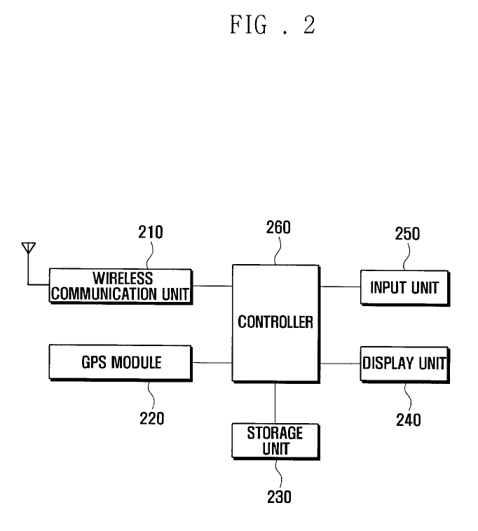

FIG. 2 shows configuration of a mobile terminal employed in the exemplary embodiment of the present invention.

A wireless communication unit 210 performs transmission and reception of corresponding data for the wireless communication of the mobile terminal. The wireless communication unit 210 may include, for example, an RF transmitter to up-convert and amplify a frequency of transmitted signals and an RF receiver to perform low-noise amplification of the received signals and to down-convert the frequency of the received signals. The wireless communication unit 210 may receive data through a wireless channel to output the received data to a controller 260, and may transmit data output from the controller 260 through the wireless channel.

A GPS module 220 receives the GPS satellite signals from GPS satellites. The GPS module 220 is preferably divided into two blocks. A high frequency unit converts signals of 1.2 and 1.5 GHz received through an antenna into low frequency signals which may be easily handled. A signal processor acquires messages received from the satellites and their pseudorange by performing despreading to restore spectrum spread.

A storage unit 230 may include a program memory and a data memory that are machine readable. The program memory may store programs comprising executable for controlling general operations of a mobile terminal and programs for driving the GPS module 220 in this exemplary embodiment of the present invention. The data memory temporally stores data generated during the execution of the programs.

A display unit 240 may comprise a liquid crystal display (LCD), or any other type of thin-film screen, and visually provides to a user of the mobile terminal a menu of the mobile terminal, input data, function setting information, and other various kinds of information. For example, the display unit 240 outputs a boot screen, an idle screen, a display screen, a dialing screen, and other application executing screens. The display unit 240 may includes a controller to control the LCD, a video memory to store image data, and devices of the LCD. When the information of GPS satellite signals is transmitted to the base station 130, the respective display units 240 of the mobile terminals, 102 and 104, may display a message for determining whether or not to transmit the data. The display units 240 of the mobile terminals 102 and 104 may display a message notifying of the reception of assistance data when the assistance data is received from the base station 130, and may display a message to indicate whether the GPS satellite signals are received from the GPS satellites 110.

An input unit 250 receives key manipulation signals for controlling a mobile terminal by the user and delivers the received key manipulation signals to the controller 260. The input unit 260 may include a key pad having alphanumeric keys and arrow keys. When the display unit 240 comprises a touch screen, the input unit 250 may be coupled with the display unit 240.

The controller 260 controls overall operation of the mobile terminal and signal flow between internal blocks of the mobile terminal. The controller 260 controls the wireless communication unit 210 to transmit a call signal to the base station 130. In this exemplary embodiment of the present invention, the call signal may be a call and may be transmitted by connecting the call corresponding to an emergency rescue request. For example, when a user inputs a phone number ‘911’ and presses a call button, a call signal is transmitted to the base station 130. The user may also activate an emergency request by pressing an emergency button, moving/sliding a switch or a cover to activate an emergency request. Moreover, in this exemplary embodiment of the present invention, the call signal may be a short message service (SMS) message.

When the assistance data is received from the base station 130, the controller 260 controls the GPS module 220 to receive the GPS satellite signal from the GPS satellite 110. The controller 260 transmits information on the GPS satellite signals contained in the GPS satellite signal to the base station 130 through the wireless communication unit 210. The base station 130 locates the mobile terminal 100 using the information on the GPS satellite signals received from the wireless communication unit 210.

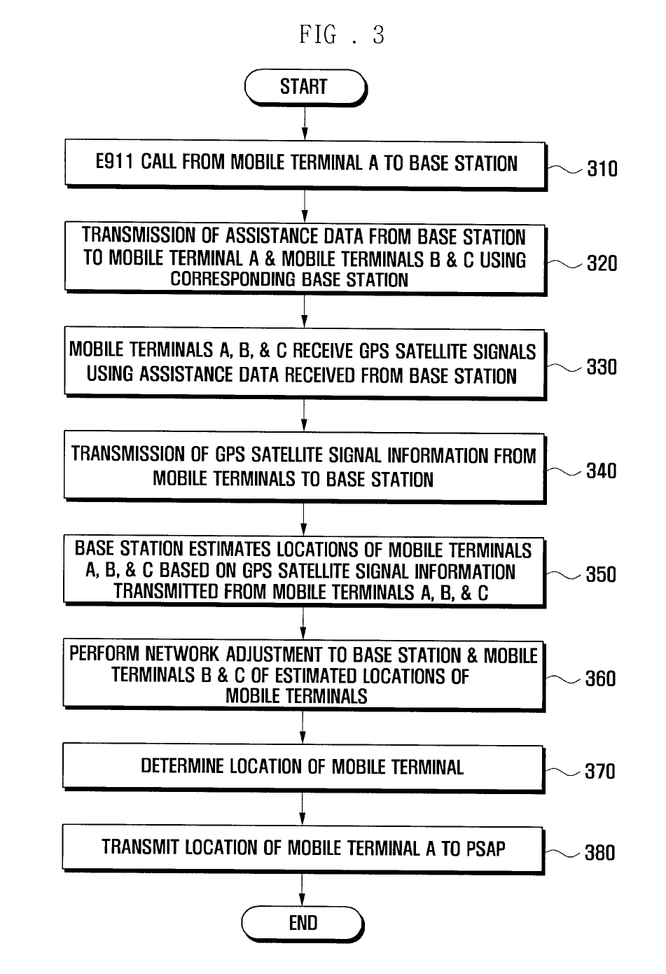

FIG. 3 is a flowchart illustrating an operational example of a method of locating the mobile terminal 100 according to an exemplary embodiment of the present invention.

For the purpose of clarifying the description of the present invention, the mobile terminal 100 that transmits an emergency call signal is referred to as a “mobile terminal A”. Mobile terminals 102 and 104, which transmit the information on the GPS satellite signals to the base station 130 but do not transmit the emergency call signals, are referred to as a “mobile terminal B” and a “mobile terminal C”, respectively. In addition, the mobile terminal for transmitting the information on the GPS satellite signals to the base station 130 may include the mobile terminals B and C and other mobile terminals D and E and the number of mobile terminals may be changed according to a setting condition.

In step 310, the mobile terminal A transmits an emergency call signal to the base station 130. The emergency call signal may be, for example, a ‘911 call’. When the emergency call signal is received from the mobile terminal A, the base station 130 transmits the assistance data to the mobile terminal A and the mobile terminals B and C which use a corresponding base station 130 (320). The assistance data employed in this exemplary embodiment of the present invention is referred to as data on the GPS satellites and contains information on a GPS satellite whose GPS signals may be received, such as, for example a PRN number of a satellite, ephemeris data, and other corrections.

The base station 130 may select a mobile terminal to receive the assistance data among mobile terminals having GPS modules and use the same base station 130 as the base station 130 which the mobile terminal 100 uses. When the mobile terminal A uses the mobile communication service through a repeater, a mobile terminal that receives the assistance data uses the same repeater as that used by the mobile terminal A and may be selected from the mobile terminals, each of which includes GPS modules. In this way, a more accurate location determination is made of the mobile terminal making the emergency assistance call.

The base station 130 may be selected according to a manufacturer of mobile terminals when the mobile terminal to receive the assistance data is selected. For example, when the mobile terminal A is manufactured by a company ‘S’, the base station 130 may select a mobile terminal to receive the assistance data from mobile terminals which use the same base station 130 as that used by the mobile terminal A, each of which includes a GPS module, and which are manufactured by the same company as that of the mobile terminal A. While the aforementioned is not required, the uniformity would eliminate differences in design of the mobile terminals that could impact the data.

The base station 130 may select the mobile terminal to receive the assistance data using, for example, a serial number or a subscriber identity module (SIM) number of the mobile terminal. Since the mobile terminal A contains a unique serial number and the base station 130 has data on the serial number of the mobile terminal A, the mobile terminal to receive the assistance data may be selected from mobile terminals having serial numbers within a range set according to the serial number of the mobile terminal A. When the mobile terminal A has, for example, a SIM card or a universal subscriber identity module (USIM) card, since the base station 130 has data on the SIM or USIM number of the mobile terminal A, the base station 130 may select the mobile terminal to receive the assistance data from mobile terminals having the SIM or USIM number within a range set according to the SIM or USIM number of the mobile terminal A.

The base station 130 selects the mobile terminal to receive the assistance data based on a preset criterion. In the exemplary embodiment of FIG. 3, the mobile terminals B and C are selected as the mobile terminals to receive the assistance data. The base station 130 transmits the assistance data to the mobile terminals A, B, and C (320).

The mobile terminal A receives the GPS satellite signals from the GPS satellites 110 using the assistance data received from the base station 130 (330). Each of the GPS satellite signals contains data used to determine a location of the mobile terminal A, such as a transmission rate and time of the GPS satellite signals. For a clearer understanding of the present invention, data contained in the GPS satellite signals are referred to as ‘GPS satellite signal information’.

The mobile terminals B and C receive the GPS satellite signals using the assistance data received from the base station 130 (330). Each of the GPS satellite signals contains data used to determine the locations of the mobile terminals B and C. Considering the mobile terminal B, when the assistance data is transmitted from the base station 130 to the mobile terminal B, the controller 260 of the mobile terminal B controls the GPS module 220 to receive the GPS signals from the GPS satellites 110. When the mobile terminal B receives the assistance data from the base station 130, the mobile terminal B may be in an idle state, in a busy state, or may be executing other applications. Regardless of the status of the mobile terminal B, the controller 260 of the mobile terminal B controls the GPS module 220 to receive the GPS satellite signals from the GPS satellites 110. When another function is being executed, the controller 260 controls the GPS module 220 to receive the GPS satellite signals in multitasking mode. This processing may be applied to the mobile terminal C in the same manner.

The mobile terminals A, B, and C all transmit the GPS satellite signal information on the received GPS satellite signals to the base station 130 (340).

In the mobile terminal A, the controller 260 of the mobile terminal A controls the wireless communication unit 220 to transmit the GPS satellite signal information containing the data for determining the location of the mobile terminal A to the base station 130.

Even in the mobile terminal B, the controller 260 of the mobile terminal B controls the wireless communication unit 210 to transmit the GPS satellite signal information containing the data for determining the location of the mobile terminal B to the base station 130. In this case, in order to prevent the GPS satellite signal information from being transmitted to the base station 130 while a user of the mobile terminal B does not perceive the transmission, the controller 260 of the mobile terminal B, when the assistance data is transmitted to the mobile terminal B, controls the display unit 240 to provide notification by displaying a message facilitating the user of the mobile terminal B in this example to select whether to transmit the GPS satellite signal information. In this exemplary embodiment of the present invention, the message may be provided in the form of a pop-up window. When the user of the mobile terminal B selects a command to allow the transmission of the GPS satellite signal information, the GPS satellite signal information is transmitted to the base station 130. This transmission in the mobile terminal B may be likely applied to the mobile terminal C. It is also possible that subscribers to the mobile service may pre-authorize such transmissions as a condition of their contract to take advantage of this aspect of the present invention should the need arise for themselves or others in the event of an emergency.

When the base station 130 receives the GPS satellite signal information from the mobile terminals A, B, and C, the base station 130 then calculates the locations of the mobile terminals A, B, and C using the assistance data that is transmitted to the mobile terminals A, B, and C in step 320 and the GPS satellite signal information received in step 340. By doing so, the base station 130 may determine the locations of the mobile terminals A, B, and C.

The base station 130 starts network adjustment with respect to the locations of the mobile terminals B and C and the base station 130 among the locations of the mobile terminals A, B, and C that are calculated in step 350 and the base station 130. In the network adjustment, a coordinate of an unknown position is adjusted by a network using a measured distance, measuring angle, and azimuth.

In more detail, in the network adjustment, a coordinate of an unknown position is preferably calculated with reference to a fixed position. It is assumed that the location of the mobile terminal A is distributed in an undefined wide range so that it is difficult to determine the location of the mobile terminal A. In this case, it is considered that the mobile terminal A is at the unknown position. It is assumed that the mobile terminals B and C are located on a plain, that the GPS modules are experiencing good signal conditions, and that the locations of the mobile terminals B and C are distributed in a narrow range. In this case, there can be an assumption that the locations of the mobile terminals B and C correspond to the fixed position.

The base station 130 measures the location of the mobile terminal A for a set number of times. In this exemplary embodiment of the present invention, it is assumed that the location of the mobile terminal A is measured 100 times. The base station 130 acquires position values A1, A2, . . . , A100, with respect to the location of the mobile terminal A, which are two or three dimensional coordinates. The base station 130 measures respective distances from the location of the base station 130, that is, the fixed location, to the position values A1, A2, . . . , A100. The measured distances between the base station 130 and the respective locations “An” are referred to as a1, a2, . . . , a100. The measured distances a1 to a100 contain real distances and erroneous distances between the location of the base station 130 and the mobile terminal A. Thus, one of the measured distances is referred to as a reference distance to calculate error with respect to the measured distances. For example, when a5 is referred to as the reference distance, the base station 130 calculates erroneous distances between a5 and a1 to a100. That is, the base station 130 calculates distance differences between a1 and a5, a2 and a5 to a100 and a5 sequentially. The calculated distance differences correspond to the erroneous distances. The reference distance may be an average of a1, a2, . . . , a100. When the erroneous distances calculated with respect to the coordinate A5 corresponding to the reference distance a5 is applied, a location range of the mobile terminal A is estimated. The location range of the mobile terminal A corresponds to a location range in which the reference coordinate A1 is a center and the erroneous distance is a diameter. During estimation of the erroneous distances, absolute values or squares of the distance differences between a5 and a1 to a5 and a100 may be used. Moreover, the erroneous distances corresponding to the diameter may be an average, maximum, or minimum of the erroneous distances (absolute values).

According to the present invention, the location range of the mobile terminal A may be determined with respect to the locations of the mobile terminals B and C as well as the location of the base station 130 as the fixed location. When the base station 130 receives the GPS satellite signal information from the mobile terminal B, the base station 130 determines the location of the mobile terminal B based on the information. When it is assumed that the location of the mobile terminal B is measured 100 times, the base station 130 acquires coordinates of the mobile terminal B corresponding to B1, B2, . . . , B100. When it is assumed that the location coordinates of the mobile terminal B are distributed within a very narrow range, it may be determined that B1=B2= . . . =B100. The estimation of the location of the mobile terminal B is identical to that of the mobile terminal C. Thus, the base station 130 acquires location coordinates of the mobile terminal C, C1, C2, . . . , C100 and it may be determined that C1=C2= . . . =C100.

The base station 130 measures distances from the location of the base station 130 to An, distances from “Bn” to An, and distances from “Cn” from An. The base station 130 acquires measured distances from Bn to An such as b1, b2, . . . , b100 and distances from Cn to An such as c1, c2, . . . , c100. The base station 130 determines respective reference distances of b1, b2, . . . , b100 and c1, c2, . . . , c100, and calculates errors with respect to the measured distances. For example, considering the mobile terminal B, when b5 is referred to as a reference distance, the base station 130 calculates erroneous distances from b5 to b1 to b100. That is, the base station 130 calculates a distance difference between b1 and b5, a distance difference between b2 and b5, and so on, sequentially and a distance difference between b1 and b100. In this case, the calculated distance differences (absolute values) correspond to the erroneous distances. The reference distance may correspond to an average of b1, b2, . . . , b100. Moreover, when the coordinate A5 corresponding the reference distance b5 is applied to the calculated erroneous distances, the location range of the mobile terminal A is estimated. The location range of the mobile terminal A corresponds to a location range circle centered upon the reference coordinate A5 and a radius equal to the erroneous distance (absolute value). The erroneous distance may be the average, the maximum, or the minimum of the erroneous distances. This estimation may be identically applied to the mobile terminal C.

After that, the location range of the mobile terminal A is limited to a location range satisfying all of the location range of the mobile terminal A calculated with respect to the location of the base station 130, the location range of the mobile terminal A with respect to the location of the mobile terminal B, and the location range of the mobile terminal A calculated with respect to the location of the mobile terminal C. When there are mobile terminals D and E in addition to the mobile terminals B and C as the reference locations, distances to all other mobile terminals as the reference locations are measured so that the location range of the mobile terminal A is determined. With the estimation, a distribution range within which the mobile terminal A may be located may be lower than the network adjustment of the location of the mobile terminal A with respect to only the location of the base station 130.

According to this exemplary embodiment of the present invention, the base station 130 may perform the network adjustment after applying errors between a real location of the base station 130 and the locations measured by the base station 130 to the mobile terminals A, B, and C.

Since the location of base station 130 is fixed, a precise coordinate of the real location is known. The base station 130 includes a location server so that the location of the base station 130 may be measured using the plurality of GPS satellites 110. When GPS satellite signals are received, an error occurs due to a clock error, ionospheric correction, and Doppler effect. This error is applied to the mobile terminals A, B, and C distributed in the coverage of the base station 130. Thus, the base station 130 calculates the error between the real location and the measured location and applies the error to the locations of the mobile terminals A, B, and C to estimate new locations of the mobile terminals A, B, and C. Since error correction is performed before network adjustment, in this case the location range of the mobile terminal A may be more precise than when the network adjustment is directly performed.

The base station 130 determines the location of the mobile terminal A (370) and transmits the determined location of the mobile terminal A to the PSAP 140 (380). The base station 130 uses the locations of the mobile terminals B and C as additional fixed locations so that a location range where the mobile terminal A may be located may be restricted.

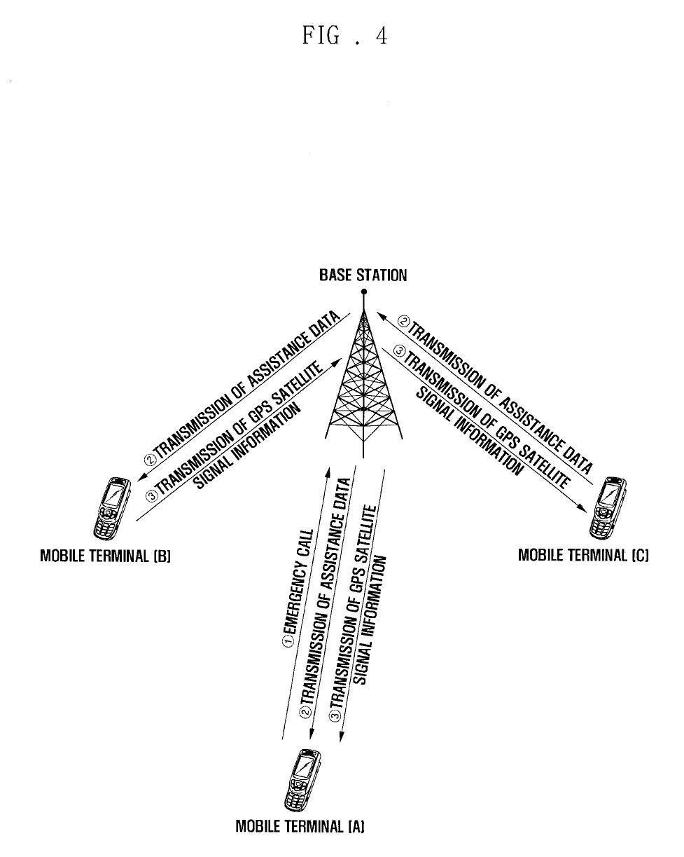

FIG. 4 is a schematic view illustrating data transmission between the base station and the mobile terminals A, B, and C according to an exemplary embodiment of the present invention.

The mobile terminal A transmits an emergency call signal to the base station (1). When the emergency call signal is received, the base station 130 selects mobile terminals to receive the assistance data. The base station 130 transmits the assistance data to the mobile terminal A that transmitted the emergency call signal and the mobile terminals B and C selected as mobile terminals to receive the assistance data. The mobile terminals A, B, and C that received the assistance data receive the GPS satellite signals from the GPS satellites 110 (such as shown in FIG. 1) and transmit the GPS satellite signal information to the base station 130. The base station 130 calculates the locations of the mobile terminals A, B, and C and determines the locations of the mobile terminals A, B, and C using the calculated locations. After that, the base station 130 estimates the location range of the mobile terminal A using the locations of the base station 130 and the mobile terminals B and C.

Using the method and the system for locating a mobile terminal according to the present invention, the location range where the mobile terminal A is located is narrowed so that the location of the mobile terminal A may be precisely determined in comparison to the case when the location of the mobile terminal A is determined.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A method for locating a mobile terminal based on a assisted global system, comprising:
transmitting assistance data by a base station to a caller mobile terminal and to at least one other terminal when the base station receives a call signal from the mobile caller terminal;
receiving GPS satellite signal information from the caller mobile terminal and the at least one other terminal;
determining a location of the caller mobile terminal and a location of the at least one other terminal based on the assistance data and the GPS satellite signal information; and
estimating a location range of the caller mobile terminal by correcting the location range of the caller mobile terminal using the location of the at least one other terminal and a location of its base station.

2. The method of claim 1, wherein, in estimating the location range of the caller mobile terminal, a network adjustment is performed to estimate the location range of the caller mobile terminal with respect to the locations of the base station and said at least one another terminal as reference locations.

3. The method of claim 1, wherein, in determining the location of the caller mobile terminal, an error between a real location of the base station and an estimated location of the base station from a GPS satellite signal is applied to the location of the caller mobile terminal and the location of said at least one other terminal for determining the locations of the caller mobile terminal and said at least one another terminal.

4. The method of claim 3, wherein estimating the location range of the caller mobile terminal comprises performing the network adjustment using the location of said at least one other terminal and the real location of the base station.

5. The method of claim 2, wherein the estimation of the location range of the caller mobile terminal comprises:
estimating a distance error between the location of the caller mobile terminal and the location of the base station and a distance error between the location of the caller mobile terminal and the location of said at least one other terminal; and
estimating the location range of the caller mobile terminal based on the distance errors.

6. The method of claim 1, wherein said at least one other terminal of terminals using the same base station as the base station which the caller mobile terminal uses.

7. An assisted global positioning system-based locating system, comprising:
a plurality of mobile terminals, each of which includes a GPS module; and
a base station transmitting assistance data to the mobile terminals when receiving a call signal from one of the mobile terminals, determining locations of the mobile terminals based on GPS satellite signal information and the assistance data when the GPS satellite signal information is received from the mobile terminals, and estimating a location range of the mobile terminal which transmitted the call signal using the locations of the mobile terminals excluding the mobile terminal which transmitted the call signal and a location of the base station.

8. The assisted global positioning system-based locating system of claim 7, wherein the base station estimates the location range of the mobile terminal which transmitted the call signal by performing network adjustment based on the locations of the mobile terminals excluding the mobile terminal which transmitted the call signal.

9. The assisted global positioning system-based locating system of claim 7, wherein the base station applies an error between a real location of the base station and a location of the base station received from a GPS satellite to the mobile terminals, and estimates the location of the mobile terminal which transmitted the call signal by performing network adjustment based on at least one of the locations of the mobile terminals excluding the location of the mobile terminal which transmitted the call signal and a correct location of the base station.
